(19) United States
(12) Patent Application Publication
(10) Pub. No.: US 2013/0212540 A1
(43) Pub. Date: Aug. 15, 2013

(54) METHOD, APPARATUS AND COMPUTER PROGRAM PRODUCT FOR ACCESSING IMAGES

(71) Applicants: Chetan Krishnamurthy, Bangalore (IN); Vineeth Neelakanth, Bangalore (IN)

(72) Inventors: Chetan Krishnamurthy, Bangalore (IN); Vineeth Neelakanth, Bangalore (IN)

(73) Assignee: NOKIA CORPORATION, Espoo (FI)

(21) Appl. No.: 13/806,671

(22) PCT Filed: Jun. 1, 2011
(86) PCT No.: PCT/FI2011/050511

§ 371 Date: Apr. 15, 2013

(30) Foreign Application Priority Data
Jun. 23, 2010 (IN) 1793/CHE/2010

(51) Int. Cl. G06F 3/0481

(52) U.S. Cl. CPC G06F 3/0481
USPC 715/854

(57) ABSTRACT

A method, an apparatus, and a computer program product are provided for accessing images. A user can move from one image to another by selecting a direction. The method includes detecting a navigation pattern for accessing images. The method further includes updating a set of cached images based upon the navigation pattern. The set of cached images includes a current set of cached images at a point of navigation, a first set of cached images in a first direction from the point of navigation and a second set of cached images in a second direction from the point of navigation.

### TECHNICAL FIELD

Various implementations relate generally to method, apparatus, and computer program product for accessing digital images in an apparatus.

### BACKGROUND

Many devices are now equipped with capabilities of capturing and/or storing of digital images. These devices may include applications such as photo viewer or similar applications such as map browser applications for accessing the digital images. These images can be rendered on a display. Such image accessing applications are typically equipped with advanced transitions effects, editing features, and user control for providing a rich access of the digital images. For example, a user can perform operations on the digital images such as scrolling the digital images, zooming in or zooming out, panning, resizing, scrolling between locations, and performing other editing features.

While performing these operations, these image accessing applications perform rendering of the digital images. These images can be rendered by offering initial display view such as a thumbnail view or a list view of the digital images. For example, a thumbnail image may be generated from an Exchangeable Image File Format (EXIF) header of a JPEG image, or can be generated by scaling and storing the original digital image at thumbnail resolution. Further, once the user selects an image from the initial display view, the original image is decompressed, scaled, and rendered on the display of the device.

With the advent of touch enabled devices, the user's capabilities to interact with such image accessing applications on such devices have increased significantly. The user may perform functions such as scrolling, zooming, and panning the digital images in a faster manner. Once a digital image is rendered on the display, navigation by the user, such as a finger movement on the display or scrolling done by the user, results in new digital images being fetched from the disk, decompressed, scaled and rendered on the display.

### SUMMARY OF VARIOUS EMBODIMENTS

Methods, computer program products, and apparatus for providing access to images are provided.

In one aspect, a method is provided. The method includes detecting a navigation pattern for accessing images. The method further includes updating a set of cached images based upon the navigation pattern, where the set of cached images includes a current set of cached images at a point of navigation, a first set of cached images in a first direction from the point of navigation and a second set of cached images in a second direction from the point of navigation.

In an embodiment, the second direction is opposite to the first direction. In an embodiment, the navigation pattern includes a direction of the navigation, a speed of the navigation, and a duration of a constant navigation. In an embodiment, the method updates the set of cached images by increasing a number of cached images in the first set of cached images if the direction of the navigation is in the first direction. The method further includes updating the set of cached images by increasing a number of cached images in the second set of cached images if the direction of the navigation is in the second direction. In an embodiment, updating the set of cached images also includes maintaining a number of cached images in the set of cached images as constant.

In an embodiment, the method updates the set of cached images by increasing the number of cached images in the set of cached images if the speed of the navigation increases. Further, the method includes updating the set of cached images by caching at least one image with reduced resolution compared to original resolution of the at least one image In an embodiment, the method includes updating the set of cached images by caching proxy image of at least one image. The method also includes updating the set of cached images by caching encoded format of at least one image. Further, the method includes updating the set of cached images by reducing the number of cached images in the set of cached images if the speed of the navigation reduces. Furthermore, the method includes updating the set of cached images by increasing a number of cached images in the first set of cached images if the speed of navigation remains within a threshold limit for a threshold period of time in the first direction. Moreover, the method includes updating the set of cached images by increasing the number of cached images in the second set of cached images if the speed of navigation remains within the threshold limit for the threshold period of time in the second direction. In an embodiment, the method includes displaying the set of cached image.

In another aspect, an apparatus is provided. The apparatus includes at least one processor, and at least one memory including computer program code. The at least one memory and the computer program code are configured to, with the at least one processor, cause the apparatus to perform at least, detect a navigation pattern for accessing images, and update a set of cached images based upon the navigation pattern. The set of cached images includes a current set of cached images at a point of navigation, a first set of cached images in a first direction from the point of navigation and a second set of cached images in a second direction from the point of navigation.

In an embodiment, the second direction is opposite to the first direction. In an embodiment, the navigation pattern includes a direction of navigation, a speed of navigation, and a duration of a constant navigation. The apparatus is further caused, at least in part, to update the set of cached images by increasing a number of cached images in the first set of cached images if the direction of navigation is in the first direction, and increasing a number of cached images in the second set of cached images if the direction of navigation is in the second direction. In an embodiment, the apparatus is further caused, at least in part, to maintain a number of cached images in the set of cached images as constant. In an embodiment, the apparatus is further caused, at least in part, to update the set of cached images by increasing the number of cached images in the set of cached images if the speed of navigation increases.

In an embodiment, the apparatus is further caused, at least in part, to update the set of cached images by caching at least one image with reduced resolution compared to original resolution of the at least one image. In an embodiment, the apparatus is further caused, at least in part, to update the set of cached images by proxy image of at least one image. In an embodiment, the apparatus is further caused, at least in part, to update the set of cached images by caching encoded format of image of the at least one image. In an embodiment, the apparatus is further caused, at least in part to, update the set of cached images by reducing the number of cached images in the set of cached images if the speed of the navigation reduces. In an embodiment, the apparatus is further caused, at least in part, to update the set of cached images by increasing the number of cached images in the first set of cached images if the speed of navigation remains within a threshold limit for a threshold period of time in the first direction and increasing the number of cached images in the second set of cached images if the speed of navigation remains within the threshold limit for the threshold period of time in the second direction. In an embodiment, the apparatus further includes a display configured to display the set of cached images.

In an embodiment, the apparatus further includes a communication apparatus. The communication apparatus includes a user interface circuitry and user interface software configured to facilitate a user to control at least one function of the communication apparatus through use of a display and configured to respond to user inputs. The communication apparatus further includes a display circuitry configured to display at least a portion of a user interface of the communication apparatus, the display and display circuitry configured to facilitate the user to control at least one function of the communication apparatus.

In yet another aspect, a computer program product including at least one computer-readable storage medium is provided. The computer-readable storage medium includes a set of instructions, which, when executed by one or more processors, cause an apparatus to perform at least detect a navigation pattern for accessing images, and update a set of cached images based upon the navigation pattern. The set of cached images includes a current set of cached images at a point of navigation, a first set of cached images in a first direction from the point of navigation and a second set of cached images in a second direction from the point of navigation.

In an embodiment, the second direction is opposite to the first direction. In an embodiment, the navigation pattern includes a direction of navigation, a speed of navigation, and a duration of a constant navigation. In an embodiment, the set of instructions, which, when executed by one or more processors, cause an apparatus, at least in part, to update the set of cached images by increasing a number of cached images in the first set of cached images if the direction of navigation is in the first direction, and increasing a number of cached images in the second set of cached images if the direction of navigation is in the second direction. In an embodiment, the apparatus is further caused, at least in part, to maintain a number of cached images in the set of cached images as constant. In an embodiment, the apparatus is further caused, at least in part, to update the set of cached images by increasing the number of cached images in the set of cached images if the speed of navigation increases.

In an embodiment, the apparatus is further caused, at least in part, to update the set of cached images by caching at least one image with reduced resolution compared to original resolution of the at least one image. In an embodiment, the apparatus is further caused, at least in part, to update the set of cached images by thumbnail image of at least one image. In an embodiment, the apparatus is further caused, at least in part, to update the set of cached images by caching encoded format of image of at least one image. In an embodiment, the apparatus is further caused, at least in part to, update the set of cached images by reducing the number of cached images in the set of cached images if the speed of the navigation reduces. In an embodiment, the apparatus is further caused, at least in part, to update the set of cached images by increasing the number of cached images in the first set of cached images if the speed of navigation remains within a threshold limit for a threshold period of time in the first direction and increasing the number of cached images in the second set of cached images if the speed of navigation remains within the threshold limit for the threshold period of time in the second direction.

In yet another aspect, an apparatus is provided. Then apparatus includes means for detecting a navigation pattern for accessing images, and means for updating a set of cached images based upon the navigation pattern. The set of cached images includes a current set of cached images at a point of navigation, a first set of cached images in a first direction from the point of navigation and a second set of cached images in a second direction from the point of navigation.

In an embodiment, the second direction is opposite to the first direction.

In still another aspect, a computer program including a set of instructions is provided. The set of instructions, when executed by an apparatus, cause the apparatus to perform at least detecting a navigation pattern for accessing images, and updating a set of cached images based upon the navigation pattern. The set of cached images includes a current set of cached images at a point of navigation, a first set of cached images in a first direction from the point of navigation and a second set of cached images in a second direction from the point of navigation.

In an embodiment, the second direction is opposite to the first direction.

In still another aspect, a method is provided. The method includes detecting a navigation pattern for accessing images. The method further includes updating a set of cached images based upon the navigation pattern. In an embodiment, the navigation pattern includes at least one of a speed of navigation, and a direction of navigation for accessing images. In an embodiment, the set of cached images includes a current set of cached images at a point of navigation, a first set of cached images in a first direction from the point of navigation and a second set of cached images in a second direction from the point of navigation, where the second direction is opposite to the first direction. In an embodiment, the navigation pattern also includes a duration of constant navigation.

### BRIEF DESCRIPTION OF THE DRAWINGS

The above-mentioned and other features and effects of this present disclosure, and the manner of attaining them, will become more apparent and the present disclosure will be better understood by reference to the following description of embodiments of the present disclosure taken in conjunction with the accompanying drawings, wherein:

FIG. 1 is a schematic diagram of a navigation pattern in an apparatus, in accordance with an embodiment;

FIG. 2 is a flowchart depicting an example of a method for providing access to images, in accordance with an embodiment;

FIG. 3 illustrates schematic representations of various sets of cached images, in accordance with an embodiment;

FIG. 4 is a flow diagram of a method for providing access to the images in an apparatus, in accordance with an embodiment;

FIG. 5 illustrates an apparatus for providing access to images, in accordance with an embodiment;

FIG. 6 is a diagram of a mobile terminal, in accordance with an embodiment; and

FIG. 7 is a diagram of computer system, in accordance with an embodiment.

### DETAILED DESCRIPTION

Example methods, apparatuses and computer program products for providing access to images are provided.

As described herein, an apparatus may be utilized to capture and/or store images. The examples of the apparatus may be any type of mobile terminal, fixed terminal, or portable terminal including a mobile handset, mobile station, mobile unit, mobile device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. The images may be captured and stored by the apparatus, or stored in the apparatus, or accessible by the apparatus from any external apparatus. Herein, for the purpose of this description, the images refer to digital photographs, digital maps, snapshots of videos or animations and other media content similar to the images.

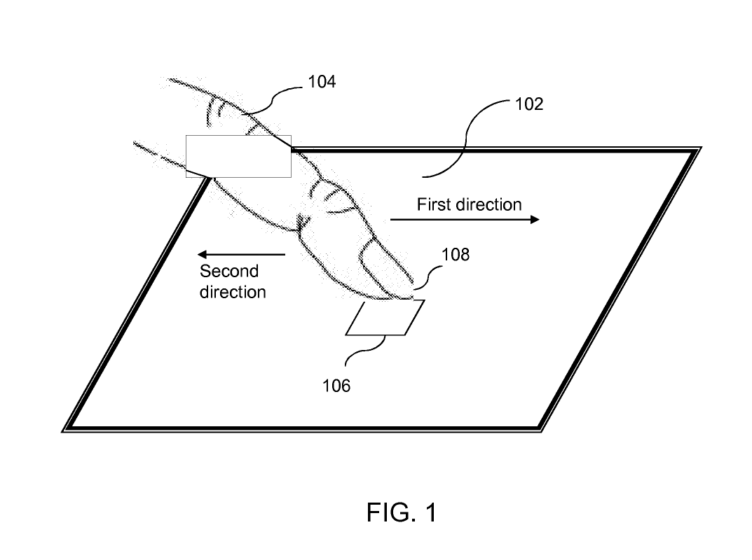

The apparatus may have a display where the images may be rendered, or the apparatus may be connected to an external apparatus that may include the display to render the images stored on the apparatus. Alternatively, the display of the apparatus may be used to render the images stored on the external apparatus. The images stored in the apparatus may be accessed a by touch enabled display, or with movement of a cursor by scrolling a mouse, a keypad, a keyboard, a joystick, a track ball, a track pad, a touch pad, mouse buttons, or using other input peripherals. One schematic diagram of a navigation pattern in an apparatus is shown in FIG. 1. A display 102 of an apparatus is represented in FIG. 1. The apparatus may comprise or may be in communication with a memory for storing images. In an embodiment, a user of the apparatus may navigate his finger 104 on the display 102 in order to access images. For example, the user may navigate and/or move the finger 104 in a first direction or a second direction. The user may navigate the finger 104 in any direction onto the display 102, and the first direction and second direction are marked as horizontal for the purposes of this description only, and should not be construed as limiting. In an embodiment, the images are navigated without an input from the user.

With the movement of the finger 104 onto the display 102, some of the images are cached from a memory. The cached images may be rendered on the display 102. For example, a cached image such as an image 106 is displayed on the display 102. The cached image 106 is displayed at a point of navigation 108. In an embodiment, with change in the point of navigation 108 (position of tip of the finger 104), new images may be cached from the memory, and such cached images may be displayed onto the display 102. Various embodiments provide methods and apparatuses for providing access to the images stored in the memory.

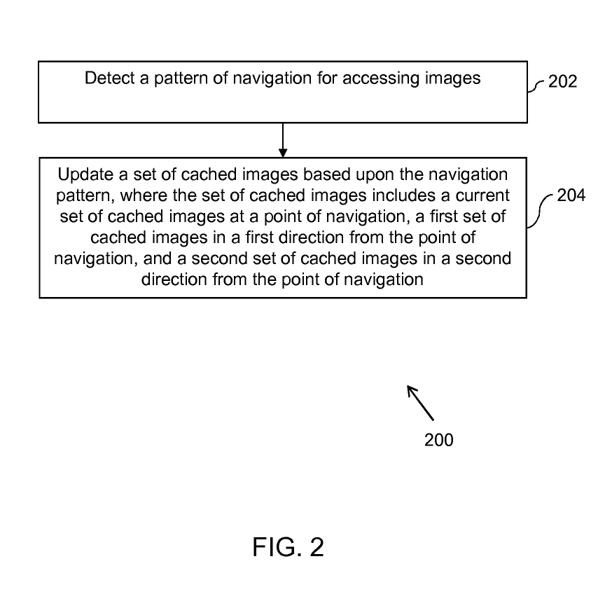

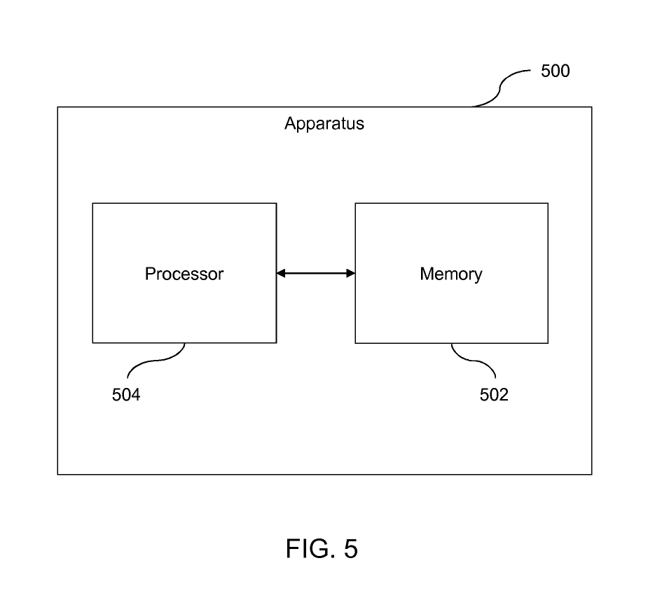

FIG. 2 is a flowchart depicting an example of a method for providing access to images, in accordance with an embodiment. At 202, the method 200 includes detecting a navigation pattern for accessing the images in the apparatus. The method 200 depicted in the flowchart may be executed by, for example, an apparatus 500 of FIG. 5. The images may be accessed by launching an image accessing application in the apparatus. Some examples of the image accessing application include Windows Picture and Fax Viewer®, Microsoft Photo Editor®, bitmap graphics editors, flash image viewer, Picasa® Viewer, Nokia Image viewer SU-5®, or map browsing applications such as Google Maps®, Nokia Maps®, Web browsers, or slide show viewer.

In one embodiment, the navigation pattern includes at least one of a direction of navigation, a speed of navigation, and a duration of a constant navigation. In an embodiment, the navigation pattern includes each of the direction of navigation, the speed of navigation, and the duration of the constant navigation. The direction of navigation is detected whether a current navigation may be in the first direction or the second direction. Further, it may be detected that whether the speed of the navigation is increasing or reducing. Further, a duration may be detected for which the navigation is constant. Herein, the constant navigation refers to a situation when the navigation remains in the same direction and speed of the navigation is within a threshold limit. Such navigation pattern may be detected by utilizing touch sensors and accompanying software, or other software and/or firmware modules in the apparatus, and the like. Such touch sensors or software and/or firmware modules may detect a navigation pattern that is in form of navigation through finger movement over the display of the apparatus, or cursor movement by scrolling a mouse, a keypad, a keyboard, a joystick, a track ball, a track pad, a touch pad, mouse buttons, or using other input peripherals.

At 204, the method 200 includes updating the set of cached images based upon the navigation pattern. In an embodiment, the set of cached images includes a current set of cached images, a first set of cached images, and a second set of cached images. The current set of cached images represents one or more cached images displayed at a point of navigation. The first set of cached images represents cached images in a first direction from the point of navigation, and the second set of cached images represents cached images in a second direction. In an embodiment, the second direction is opposite to the first direction. At any instant of using the image accessing application by the user, a set of images are cached at the point of navigation and in two opposite directions from the point of navigation. In an embodiment, at the time of launch of the image accessing application in the apparatus, a default set of images may be cached in the apparatus. However, other initialization schemes may also be possible. For example, a set of images may be cached only at a current point of navigation. In another example, a set of images may also be cached at the current point of navigation and in one of the first direction and the second direction.

In an embodiment, the images from the memory may be cached in different formats. For example, the cached images may be the images having original resolutions of their images as stored in the memory. In another example, proxy images such as thumbnail images of the images stored in the memory may be cached as the set of cached images. In another example, images with reduced resolutions may be cached in the set of cached images instead of the images having original resolutions. In another example, the cached images may be encoded format of images that are stored in the memory.

In one embodiment, updating the set of cached images comprises caching the updated set of cached images. In an embodiment, updating the set of cached images comprises changing number of cached images in any of the first set of cached images, the current set of cached images and the second set of cached images. The set of images are cached from a storage location of the images. The images may be stored in the apparatus. Alternatively, the images may also be stored in an external apparatus that may be connected to the apparatus through a wired or wireless connection. The images stored on the external apparatus may be accessed by the image accessing application of the apparatus.

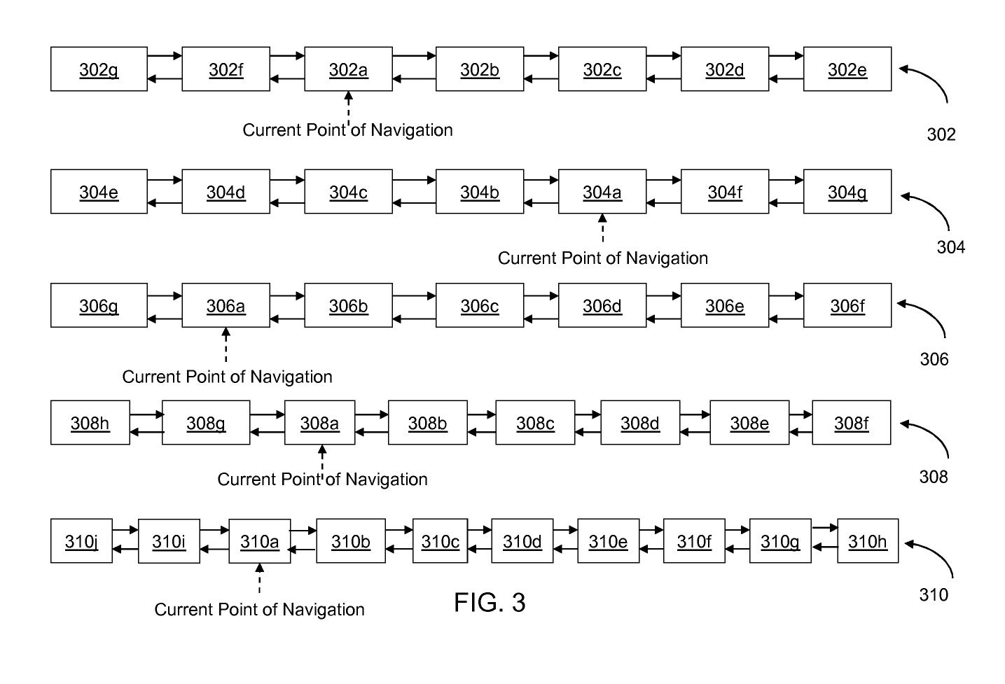

FIG. 3 illustrates schematic representations of various sets of cached images, in accordance with an embodiment. A set of cached images 302 includes a current set of cached images comprising a cached image 302a, a first set of cached images comprising cached images 302b, 302c, 302d and 302e, and a second set of cached images comprising cached images 302f and 302g. The cached image 302a is cached at a current point of navigation, and hereinafter may be interchangeably referred to as ‘current set’. Further, the first set of cached images 302b, 302c, 302d and 302e represents a set of cached images that are cached in the first direction, and hereinafter may also be referred to as ‘first set’. The second set of cached images 302f and 302g may be referred to as ‘second set’. Further, for the purpose of this description, the number of cached images in a particular set is hereinafter also referred as a ‘weight’ of the set. For example, the weight of the first set in the set of cached images 302 is ‘four’, the weight of the second set in the set of cached images 302 is ‘two’. Further, for the purpose of this description, the number of cached images in a set of cached images can also be considered a weight of the set of cached images, for example, the weight of the set of cached images 302 is ‘seven’. Weights of the current set, the first set and the second set as in the set of cached images 302 are for the purposes of this description only, and should not be construed as limiting. In an example, at a particular instance of the navigation while using the image accessing application, a set of cached images 302 are cached in the apparatus.

The set of cached images 302 is updated based on the navigation pattern. For example, the set of cached images 302 is updated, if the direction of the navigation is changed. In one embodiment, the set of cached images 302 may be updated by increasing the number of cached images (weight) in a set that is in the direction of navigation. For example, if the direction of the navigation changes in the second direction, the weight of the second set is increased. Accordingly, the set of cached images 302 can be updated to a set of cached images 304 as shown in FIG. 3. The set of cached images 304 includes four cached images 304b, 304c, 304d, and 304e in the second set and two cached images 304f and 304g in the first set. In such update from the set of cached images 302 to the set of cached images 304, the weights of the first set and the second set are interchanged. As the weight of the first set is ‘four’ and the weight of the second set is ‘two’ in the set of cached images 302 and the direction of the navigation is in the first direction, the weight of the first set is changed to ‘two’ and the weight of the second set is changed to ‘four’ in the set of cached images 304 upon change in direction of the navigation in the second direction. However, other variations in updating the set of cached images 302 may also be followed. For example, the weight of the second set may be increased to ‘four’, while maintaining the weight of the first set same, for example, ‘four’. In an embodiment, if the direction of navigation remains same, for example, in the first direction, the weight of the first set may be increased and the weight of the second set may be reduced or maintained same.

Further, the set of cached images 302 may also be updated based on the speed of the navigation. In one embodiment, if it is detected that the speed of navigation reduces, the weight of the set of cached images 302 is reduced. For example, if the speed of navigation reduces in the first direction, the weight of the first set may be reduced, for example, to ‘two’, and the weight of the second set may be maintained same, for example, ‘two’. The weight of the set of cached images 302 may also be reduced by adopting other rules as well, such as reducing the weights of both sets, the first set and the second set with the reduction in the speed of navigation. In one embodiment, the reduction in the weight of a particular set may depend upon a value by which the speed of navigation reduces.

Furthermore, if it is detected that the speed of navigation remains constant for more than the threshold period of time, the set of cached images 302 is updated by increasing the weight of a set that is in the current direction of navigation. For example, the weight of the first set may be increased if the speed is constant for more than the threshold period of time in the first direction. Herein, the set of cached images 302 can be updated based on following a constant weight strategy. For example, the weight of the set of cached images 302 is maintained as same by increasing the weight of the set in current direction of navigation and reducing the weight of the set in opposite direction of navigation. One example of such update may be updating the set of cached images 302 to a set of cached images 306. For example, the weight of the first set is increased to ‘five’ cached images 306b, 306c, 306d, 306e and 306f; and the weight of the second set is reduced to ‘one’ cached image 306g. In another embodiment, the weight of the first set may be increased without reducing the weight of the second set. Such update of the set of cached images increases the weight of the set of cached images. One example of such update may be updating the set of cached images 302 to a set of cached images 308. For example, the weight of the first set is increased to ‘five’ cached images 308b, 308c, 308d, 308e and 308f; and the weight of the second set is maintained same as ‘two’ cached images 308g and 308i.

In an embodiment, if it is detected that the speed of navigation increases in a particular direction, it may be desired that the set of cached images should include additional number of cached images in the set in the current direction of navigation. In one embodiment, the weight of a particular set may be increased by a number depending upon a value by which the speed of navigation increases. In an embodiment, the weight of a set in the current direction (for example, the first set) may be increased from ‘four’ to ‘seven’. One example of such update is where the set of cached images 302 may be updated to a set of cached images 310.

The set of cached images 308 includes seven cached images in the first set (310b, 310c, 310d, 310e, 310f, 310g and 310h), and two cached images in the second set (310i and 310j), and one cached image in the current set (310a).

In another embodiment, at least one image may be cached with lower resolution than the original resolutions of corresponding image. For example, assuming that the original resolution of the images as stored in the memory is 1024×768. Images having resolutions of 800×600 of the corresponding images stored in the memory may be cached instead of caching the original images having resolutions of 1024×768. In yet another embodiment, the cached images in the set of cached images may be proxy images such as thumbnail images of their corresponding images as stored.

The speed of navigation may also be used as a feedback to update the set of cached images that decides to cache the original images or the proxy representation, which could be the thumbnail or reduced resolution of the original images. In an embodiment, if the user accesses a particular cached image (which is of reduced resolution/thumbnail view of the cached image) for a longer duration, the original image may be cached in the set of cached images. In an embodiment, this duration may be compared against a pre-determined threshold duration, where if the user accesses a particular cached image of reduced resolution for more than the pre-determined threshold duration, the original image of the cached image is cached in the set of cached images.

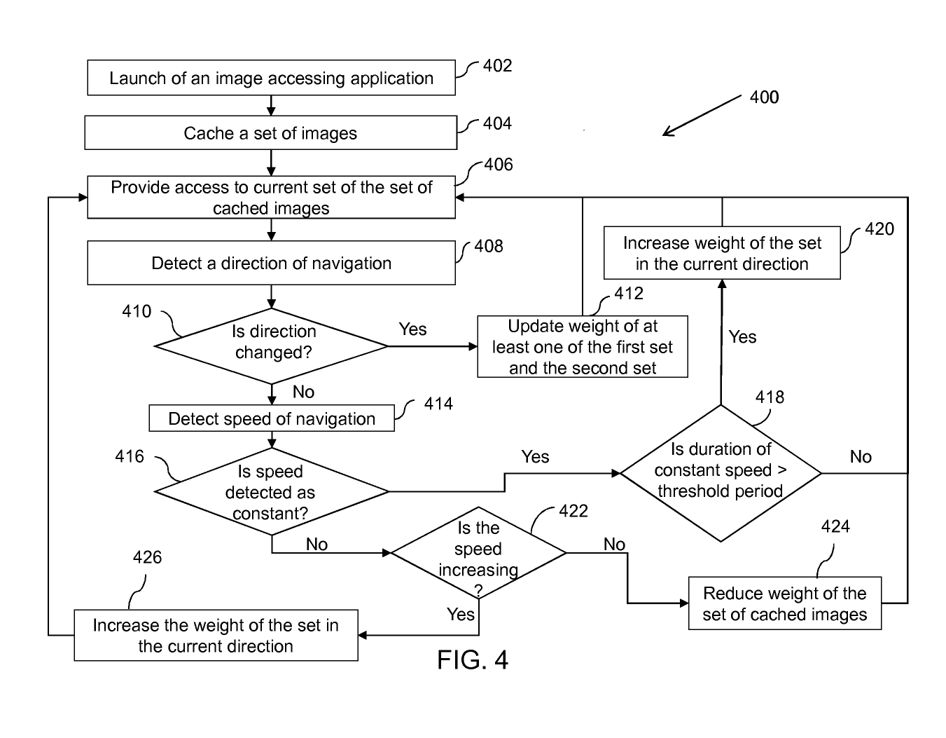

Another method for providing access to the images is further described in a flow diagram in FIG. 4. FIG. 4 is a flow diagram of a method for providing access to the images in an apparatus, in accordance with an embodiment. In an embodiment, the method 400 may be initiated by launching an image accessing application in the apparatus at 402. With the launch of the image accessing application, a set of images may be cached (hereinafter ‘set of cached images’) at 404. As explained in FIG. 2, the set of cached images may include a current set of cached images at a point of navigation, a first set of cached images in a first direction from the point of navigation, and a second set of cached images in a second direction from the point of navigation.

At 406, an image corresponding to a cached image of the current set is accessed. Further, the direction of navigation is detected at 408. At 410, it is detected whether the direction of the navigation is changed. If it is detected that the direction of the navigation is changed at 410, weight of at least one of the first set and the second set may be updated, at 412. In an example, the first direction is in the direction of navigation, and the second direction is opposite to the direction of navigation, and change in direction of the navigation is detected at 410. Accordingly, the weight of the second set is increased and the weight of the first set is reduced without changing the weight of the set of cached images at 412. In another embodiment, the weights of the first set and the second set may be interchanged. In another embodiment, the weight of the set of cached images may not be maintained as constant as the weight of the second set may be increased without changing the weight of the first set.

At 410, if it is detected that the direction of the navigation is same, for example, the direction is in the first direction, the speed of navigation is detected at 414, in one embodiment. The speed of navigation may be detected as constant for a threshold period of time, or may be detected as increasing or reducing with time. In one embodiment, it may be assumed that the speed of navigation is constant if the speed of navigation lies in a threshold limit such as lying between a first threshold speed and a second threshold speed. Further, in one embodiment, it may be assumed that the speed of navigation is increasing, if the speed of scrolling of the finger of the user increases over a first threshold duration. Similarly, it may be assumed that the speed of navigation is reducing, if the speed of scrolling of the finger of the user reduces over the first threshold duration.

At 416, it is detected whether the speed of navigation is constant. If it is determined that the speed of the navigation is constant, a duration for which the speed of navigation remains constant is compared with the threshold period of time at 418. In one embodiment, if the duration for which the speed of navigation remains constant is more than the threshold period of time, the set of cached images is updated by increasing the weight of the set that is in the current direction in the set of cached images, at 420. For example, the weight of the first set may be increased, if the current direction of the navigation is in the first direction. In an embodiment, the set of cached images is updated based on following a constant weight strategy. For example, the weight of the set of cached images is maintained same, while increasing the weight of the set in the current direction of navigation. For example, the weight of the first set may be increased and the weight of the second set is reduced, and the weight of the set of cached images is maintained as constant. In another embodiment, the weight of the first set can be increased without reducing the weight in the second set.

In an embodiment, at 416, if it is detected that the speed of navigation is not constant, it is determined whether the speed of the navigation is increasing at 422. If it is determined that the speed of the navigation is decreasing at 422, the weight of the set of cached images may be reduced, at 424. With the reduction in the speed of navigation, it may be acceptable to reduce the number of cached images in the set of cached images. Accordingly, in one embodiment, the weight of the set in the current direction may be reduced. The weight of the set of cached images may also be reduced by adopting other rules as well, such as reducing the weights of both sets, the first set and the second set with the reduction in the speed of navigation.

At 422, if it is detected that the speed of navigation increases, the weight of the set in the current direction is increased at 426. Accordingly, additional images may be cached in the set that is in the current direction of the navigation.

In an embodiment, updating the set of cached images may include caching at least one image having reduced resolutions compared to original resolution of the at least one image. In another embodiment, updating the set of cached images comprises caching proxy image of at least one image. Examples of the proxy image may be a thumbnail image, and the like. In another embodiment, updating the set of cached images comprises caching encoded format of at least one image. In an embodiment, if the user accesses a particular cached image which is one of a reduced resolution image, proxy image or image in encoded format, for a longer duration, the original image may be cached in the set of cached images. In one embodiment, this duration may be compared against a pre-determined threshold duration, where if the user accesses a particular cached image of reduced resolution for more than the pre-determined threshold duration, the original digital image of the cached image is cached in the set of cached images.

FIG. 5 illustrates an apparatus, such as an apparatus 500 for providing access to images, in accordance with an embodiment. The apparatus 500 includes at least one memory, for example, a memory 502 and at least one processor, for example, as a processor 504. The memory 502 is configured to store computer program code. In an embodiment, the memory is also configured to store the images. The memory 502 may be a volatile memory or a non volatile memory. Examples of the one or more memory 502 include, but are not limited to, a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory. Example of the at least one processor may include, but are not limited to, one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s).

The apparatus 500 may include any suitable image accessing application and images stored therein. The apparatus 500 may receive images that are stored in an external apparatus that may be connected to the apparatus through a network connection, or other wired or wireless connection. The images stored on the external apparatus may be accessed by the image accessing application of the apparatus 500. The memory 502 and the computer program code are configured to, with the processor 504, to cause the apparatus 500 to cache a set of cached images in response to the image accessing application.

As described in FIG. 2, in an embodiment, the set of cached images includes a current set of cached images, a first set of cached images, and a second set of cached images. The current set of cached images represents one or more cached images at a point of navigation. The first set of cached images represents cached images in a first direction from the point of navigation, and the second set of cached images represents cached images in a second direction opposite to the first direction.

The memory 502 and the computer program code are configured to, with the processor 504, to cause the apparatus 500 to detect a navigation pattern for accessing the images. As described in FIG. 2, in one embodiment, the navigation pattern includes a direction of navigation, a speed of navigation, and a duration of a constant navigation.

The memory 502 and the computer program code are configured to, with the processor 504, to cause the apparatus 500 to update the set of cached images (set of cached images) based upon the navigation pattern. In an embodiment, updating the set of cached images comprises updating a number of cached images in any of the first set of cached images, the current set of cached images and the second set of cached images.

In one embodiment, if the direction of the navigation is changed, the apparatus 500 is caused to update the set of cached images. In one embodiment, the apparatus 500 is caused to update the set of cached images by increasing the number of cached images (weight) in a set that is in the direction of navigation. For example, if the direction of the navigation changes in the second direction, the weight of the second set may be increased.

In one embodiment, the apparatus 500 is further caused to update the set of cached images based on the speed of the navigation. In one embodiment, the apparatus 500 is caused to detect the speed of navigation, and if it is detected that the speed of navigation reduces, the apparatus 500 is caused to reduce the weight of the set of cached images. With the reduction in the speed of navigation, it may be acceptable to reduce the number of cached images required in the set of cached images. Accordingly, in one embodiment, the weight of the set of cached images may be reduced. The weight of the set of cached images may also be reduced by adopting other rules as well, such as reducing the weight of both sets, the first set and the second set with the reduction in the speed of navigation.

If it is detected that the speed of navigation remains constant for more than the threshold period of time, the apparatus 500 is caused to update the set of cached images by increasing the weight of a set of the set of cached images that is in the current direction of navigation. For example, the weight of the first set may be increased if the current direction of the navigation is in the first direction and the speed is constant for more than the threshold period of time. Herein, the set of cached images can be updated based on following a constant weight strategy. For example, the weight of the set of cached images is maintained same, while increasing the weight of the set in the current direction of navigation (for example, the first set) and reducing the weight of the set in opposite direction of navigation (for example, the second set). In another embodiment, the weight of the first set can be increased without reducing the weight in the second set. Such update of the set of cached images leads to increase the weight of the set of cached image.

If it is detected that the speed of navigation increases in a particular direction, the apparatus 500 may be further caused to increase the weight of the set that is in the direction of navigation. In an embodiment, the apparatus 500 is caused to cache at least one image of lower resolution than original resolutions of corresponding images as stored in the memory. Alternatively, instead of reducing the resolutions of the images, proxy images such as thumbnail images of the corresponding images may also be cached in the set of cached images. In another embodiment, the apparatus 500 is caused to cache encoded format of at least one image in the set of cached images.

Some embodiments may take the form of a computer program product for providing access to images, on a computer-readable storage medium having computer-readable program instructions (e.g., computer software) embodied in the computer-readable storage medium.

Any suitable computer-readable storage medium (hereinafter ‘storage medium’) may be utilized including hard disks, CD-ROMs, RAMs, ROMs, Flash memories, optical storage devices, or magnetic storage devices.

Various embodiments are described above with reference to block diagrams of apparatus and flowchart illustrations of methods. Functionalities of various blocks of the block diagram and flowchart illustrations, and combinations of functionalities of various blocks of the block diagrams and the flowchart illustrations, respectively, may be implemented by a set of computer program instructions. These set of instructions may be loaded onto a general purpose computer, special purpose computer, or other programmable data processing apparatus to produce a machine, such that the set of instructions when executed on the computer or other programmable data processing apparatus create a means for implementing the functions specified in the flowchart block or blocks. Although other means for implementing the functions including various combinations of hardware, firmware and software as described herein may also be employed.

These computer program instructions may also be stored in a computer-readable medium that can direct a computer or other programmable data processing apparatus to function in a particular manner, such that the instructions stored in the computer-readable memory produce an article of manufacture including computer-readable instructions for implementing the function specified in the flowchart of the methods 200 or 400. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing functions/methods specified in the flowchart of the methods 200 and/or 400.

In one embodiment, an apparatus for providing access to images stored in the apparatus or in any external apparatus accessible by the apparatus is provided. The apparatus may include various means for performing at least one function in accordance with various embodiments, including those shown and described herein. It should be understood that the apparatus may include alternative means for performing at least one like functions, without departing from the spirit and scope of the present disclosure.

An entity capable of operating as apparatus (for example, the apparatus 500) may include means for detecting a navigation pattern of user input for accessing the images in the apparatus. The apparatus further includes means for updating a set of cached images based upon the navigation pattern of the user input. The set of cached images includes a current set of cached images at a point of navigation, a first set of cached images in a first direction from the point of navigation, and a second set of cached images in a second direction from the point of navigation. In an embodiment, the second direction is in opposite direction to the first direction. Such means of the apparatus may be implemented using hardware, software, firmware, or combination thereof. For the sake of brevity of the description, the functionalities of said means for providing access to the images are not described again as these functionalities are already described in the flowcharts of methods 200, and 400, and the apparatus 500.

The processes described herein for providing access to images may be implemented via software, hardware, firmware or a combination of software and/or firmware and/or hardware. For example, the processes described herein, including updating the set of cached images and detecting a navigation pattern of user input, may be advantageously implemented via processor(s), Digital Signal Processing (DSP) chip, an Application Specific Integrated Circuit (ASIC), Field Programmable Gate Arrays (FPGAs), etc. Such hardware for performing the described functions is detailed below.

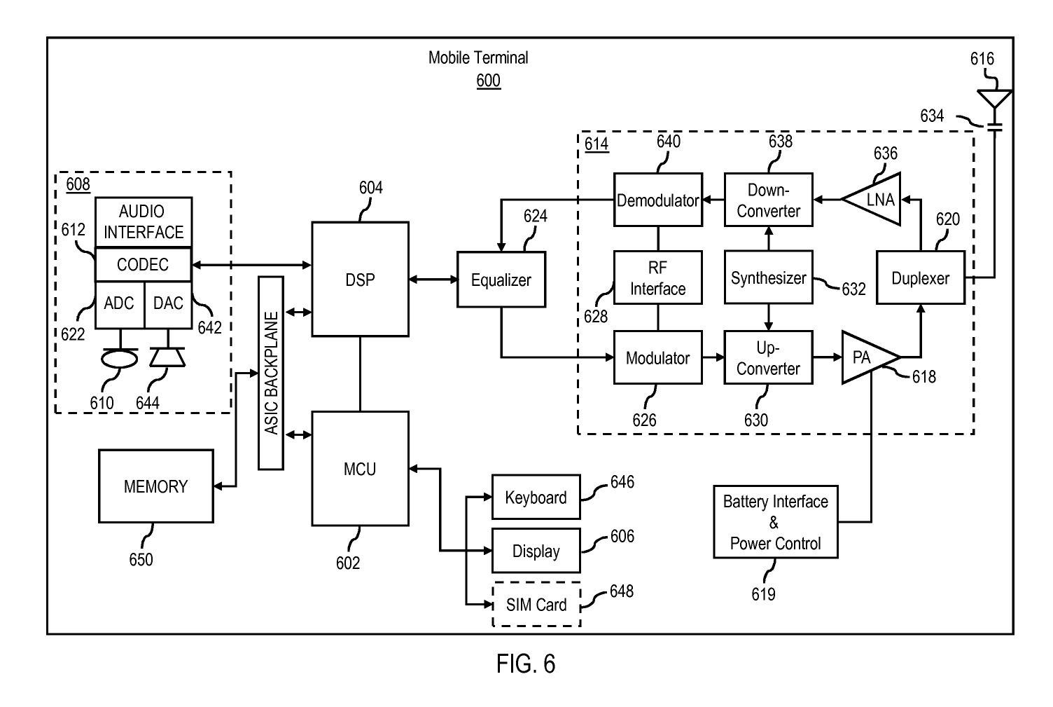

FIG. 6 is a diagram of a mobile terminal 600, in accordance with an embodiment. The mobile terminal 600 may be an example of the apparatus 500, or means for providing access to images as described above, according to one embodiment. Further, the methods described herein such as the methods 200, 400 and other variations thereof can be implemented in the mobile terminal 600. In some embodiments, mobile terminal 600, or a portion thereof, constitutes a means detecting a navigation pattern of user input, and updating a set of cached images based on the navigation pattern. Generally, the mobile terminal 600 is often defined in terms of front-end and back-end characteristics. The front-end of the mobile terminal 600 encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the mobile terminal 600 include a Main Control Unit (MCU) 602, a Digital Signal Processor (DSP) 604, and a receiver/transmitter unit including a microphone gain control unit and a speaker gain control unit. A main display unit 606 provides a display to the set of cached images responsive to the image accessing application, and to display the updated set of cached images based on the navigation pattern. The display 606 includes display circuitry configured to display at least a portion of a user interface of the mobile terminal 600 (e.g., mobile telephone). Additionally, the display 606 and display circuitry are configured to facilitate user control of at least some functions of the mobile terminal 600. An audio function circuitry 608 includes a microphone 610 and microphone amplifier that amplifies the speech signal output from the microphone 610. The amplified speech signal output from the microphone 610 is fed to a coder/decoder (CODEC) 612.

A radio section 614 amplifies power and converts frequency in order to communicate with a base station, which is included in a mobile communication system, via antenna 616. The power amplifier (PA) 618 and the transmitter/modulation circuitry are operationally responsive to the MCU 602, with an output from the PA 618 coupled to the duplexer 620 or circulator or antenna switch, as known in the art. The PA 618 also couples to a battery interface and power control unit 619.

In use, a user of the mobile terminal 600 speaks into the microphone 610 and his or her voice along with any detected background noise is converted into an analog voltage. The analog voltage is then converted into a digital signal through the Analog to Digital Converter (ADC) 622. The control unit 602 routes the digital signal into the DSP 604 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 624 for compensation of any frequency-dependent impairments that occur during transmission though the air such as phase and amplitude distortion. After equalizing the bit stream, the modulator 626 combines the signal with a RF signal generated in an RF interface 628. The modulator 626 generates a sine wave by way of frequency or phase modulation. In order to prepare the signal for transmission, an up-converter 630 combines the sine wave output from the modulator 626 with another sine wave generated by a synthesizer 632 to achieve the desired frequency of transmission. The signal is then sent through a PA 618 to increase the signal to an appropriate power level. In practical systems, the PA 618 acts as a variable gain amplifier whose gain is controlled by the DSP 604 from information received from a network base station. The signal is then filtered within the duplexer 620 and optionally sent to an antenna coupler 634 to match impedances to provide maximum power transfer. Finally, the signal is transmitted via antenna 616 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 600 are received via antenna 616 and immediately amplified by a low noise amplifier (LNA) 636. A down-converter 638 lowers the carrier frequency while the demodulator 640 strips away the RF leaving only a digital bit stream. The signal then goes through the equalizer 624 and is processed by the DSP 604. A Digital to Analog Converter (DAC) 642 converts the signal and the resulting output is transmitted to the user through the speaker 644, all under control of a Main Control Unit (MCU) 602—which can be implemented as a Central Processing Unit (CPU) (not shown).

The MCU 602 receives various signals including input signals from the keyboard 646. The keyboard 646 and/or the MCU 602 in combination with other user input components (e.g., the microphone 610) comprise a user interface circuitry for managing user input. The MCU 602 runs a user interface software to facilitate user control of at least some functions of the mobile terminal 600 to navigate to access images and display the set of cached images based on the navigation pattern. The MCU 602 also delivers a display command and a switch command to the display 807 and to the speech output switching controller, respectively. Further, the MCU 602 exchanges information with the DSP 604 and can access an optionally incorporated SIM card 648 and a memory 650. In addition, the MCU 602 executes various control functions required of the terminal. The DSP 604 may, depending upon the implementation, perform any of a variety of conventional digital processing functions on the voice signals. Additionally, DSP 604 determines the background noise level of the local environment from the signals detected by microphone 610 and sets the gain of microphone 610 to a level selected to compensate for the natural tendency of the user of the mobile terminal 600.

The CODEC 612 includes the ADC 622 and DAC 642. The memory 650 stores various data including call incoming tone data and is capable of storing other data including music data received via, e.g., the global Internet. The software module could reside in RAM memory, flash memory, registers, or any other form of writable storage medium known in the art. The memory 650 may be, but not limited to, a single memory, CD, DVD, ROM, RAM, EEPROM, optical storage, or any other non-volatile storage medium capable of storing digital data.

An optionally incorporated SIM card 648 carries, for instance, important information, such as the cellular phone number, the carrier supplying service, subscription details, and security information. The SIM card 648 serves primarily to identify the mobile terminal 600 on a radio network. The card 648 also contains a memory for storing a personal telephone number registry, text messages, and user specific mobile terminal settings.

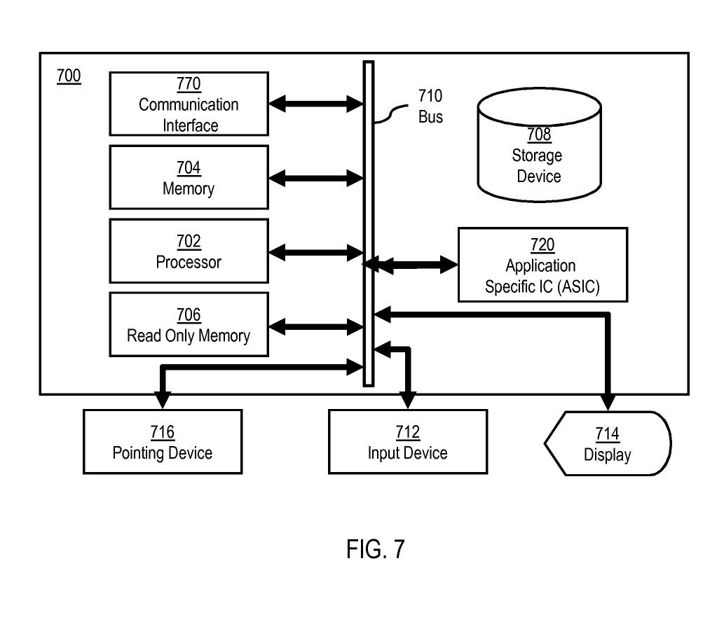

FIG. 7 illustrates a diagram of a computer system 700, in accordance with an embodiment. The computer system 700 may be an example of the apparatus 500, or means for providing access to images as described above, according to one embodiment. Further, the methods described herein such as the methods 200, 400 and other variations thereof can be implemented in the computer system 700. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to update the set of cached images based on the navigation pattern of the user input as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for detecting a navigation pattern for accessing images, and updating a set of cached images based on the navigation pattern.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to detect a navigation pattern for accessing images, and update a set of cached images based on the navigation pattern. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Operations of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage apparatus, stores information including processor instructions for detecting a navigation pattern for accessing images, and updating a set of cached images based on the navigation pattern. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage apparatus coupled to the bus 710 for storing static information, including instructions, that is not changed by the computer system 700. Some memory is composed of volatile storage that loses the information stored thereon when power is lost. Also coupled to bus 710 is a non-volatile (persistent) storage apparatus 708, such as a magnetic disk, optical disk or flash card, for storing information, including instructions, that persists even when the computer system 700 is turned off or otherwise loses power.

Information, including instructions for providing the set of cached images field may be provided to the bus 710 for use by the processor from an external input device 712, such as a touch screen, keyboard containing alphanumeric keys operated by a human user, PS2 mouse or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. In an embodiment, the storage device 708 may be utilized to store images. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

At least some embodiments of the disclosure are related to the use of computer system 700 for implementing some or all of the techniques described herein. According to one embodiment, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708. Execution of the sequences of instructions contained in memory 704 causes processor 702 to perform one or more of the method steps described herein. In alternative embodiments, hardware, such as ASIC 720, may be used in place of or in combination with software to implement the some embodiments of the disclosure. Thus, embodiments of the disclosure are not limited to any specific combination of hardware and software, unless otherwise explicitly stated herein.

Based on the foregoing, methods, apparatuses and computer program products are provided for providing access to the images. Various embodiments of the present disclosure provide caching of images in two opposite directions from a point of navigation. Such caching of the images improves handling sudden changes in the direction of navigation. Further, weight of the set of cached images is dynamically updated that handles the situation where the speed of navigation suddenly increases or reduces.

Various embodiments are mainly aimed at improving user experience while navigating through image accessing applications such as photo viewer and editor, slide show viewers, maps, and the like. These embodiments aim at combining viewing direction, speed and duration of the navigation uniquely and efficiently to cache images so that the user experience is improved to a large extent. Dynamic update of the weight of the set of cached images described herein is uniquely derived from the aforementioned parameters such as speed, direction and duration during the navigation. Various embodiments also provide means to switch between full resolution and proxy images based on combining parameters such as speed of the navigation, user actions and apparatus processing capabilities. By adapting these embodiments, the user should benefit from being able to access images of choice even at high navigations speeds and sudden changes in direction of the navigation.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

1. A method comprising:
detecting a navigation pattern for accessing images; and
updating a set of cached images based upon the navigation pattern, wherein the set of cached images comprises a current set of cached images at a point of navigation, a first set of cached images in a first direction from the point of navigation, and a second set of cached images in a second direction from the point of navigation.

2. The method of claim 1, wherein the navigation pattern comprises one or more of a direction of navigation, a speed of navigation, and a duration of a constant navigation.

3. The method of claim 1, wherein updating the set of cached images comprises:
increasing a number of cached images in the first set of cached images if the direction of the navigation is in the first direction; and
increasing a number of cached images in the second set of cached images if the direction of the navigation is in the second direction.

4-5. (canceled)

6. The method of claim 1, wherein updating the set of cached images comprises:
caching at least one image with reduced resolution compared to original resolution of the at least one image;
caching proxy image of at least one image; or
caching encoded format of at least one image.

7-9. (canceled)

10. The method of claim 1, wherein updating the set of cached images comprises:
increasing the number of cached images in the first set of cached images if the speed of navigation remains within a threshold limit for a threshold period of time in the first direction; and
increasing the number of cached images in the second set of cached images if the speed of navigation remains within the threshold limit for the threshold period of time in the second direction.

11. The method of claim 1, further comprising displaying the set of cached images.

12. (canceled)

13. An apparatus comprising:
at least one processor; and
at least one memory comprising computer program code, the at least one memory and the computer program code configured to, with the at least one processor, cause the apparatus at least to perform:
detect a navigation pattern for accessing images; and
update a set of cached images based upon the navigation pattern, wherein the set of cached images comprises a current set of cached images at a point of navigation, a first set of cached images in a first direction from the point of navigation and a second set of cached images in a second direction from the point of navigation.

14. The apparatus of claim 13, wherein the navigation pattern comprise one or more of a direction of navigation, a speed of navigation, and a duration of a constant navigation.

15. The apparatus of claim 13, wherein the apparatus is further caused, at least in part, to update the set of cached images by:
increasing a number of cached images in the first set of cached images if the direction of navigation is in the first direction; and
increasing a number of cached images in the second set of cached images if the direction of navigation is in the second direction.

16-19. (canceled)

20. The apparatus of claim 13, wherein updating the set of cached images comprises:
caching encoded format of at least one image;
caching proxy image of at least one image; or
caching encoded format of at least one image.

21. (canceled)

22. The apparatus of claim 13, wherein the apparatus is further caused, at least in part, to update the set of cached images by:
increasing the number of cached images in the first set of cached images if the speed of navigation remains within a threshold limit for a threshold period of time in the first direction; and
increasing the number of cached images in the second set of cached images if the speed of navigation remains within the threshold limit for the threshold period of time in the second direction.

23. The apparatus of claim 13, wherein the apparatus further comprises a display configured to display the set of cached images.

24-25. (canceled)

26. A computer program product comprising at least one computer-readable storage medium, the computer-readable storage medium comprising a set of instructions, which, when executed by one or more processors, cause an apparatus to perform at least:
detect a navigation pattern for accessing images; and
update a set of cached images based upon the navigation pattern, wherein the set of cached images comprises a current set of cached images at a point of navigation, a first set of cached images in a first direction from the point of navigation and a second set of cached images in a second direction from the point of navigation.

27. The computer program product of claim 26, wherein the navigation pattern comprise a direction of navigation, a speed of navigation, and a duration of a constant navigation.

28. The computer program product of claim 26, wherein the apparatus is further caused, at least in part, to update the set of cached images by:
increasing a number of cached images in the first set of cached images if the direction of navigation is in the first direction; and
increasing a number of cached images in the second set of cached images if the direction of navigation is in the second direction.

29-30. (canceled)

31. The computer program product of claim 26, wherein the apparatus is further caused, at least in part, to update the set of cached images by caching:
at least one image with reduced resolution compared to original resolution of the at least one image;
proxy image of at least one image; or
encoded format of at least one image.

32-35. (canceled)

36. The computer program product of claim 26, wherein the apparatus is further caused, at least in part, to display the set of cached images.

37-47. (canceled)

46. An apparatus comprising:
at least one processor; and
at least one memory comprising computer program code, the at least one memory and the computer program code configured to, with the at least one processor, cause the apparatus at least to perform:
detecting a navigation pattern for accessing images; and
updating a set of cached images based upon the navigation pattern, wherein the navigation pattern comprises at least one of a speed of navigation, and a direction of navigation for accessing images.

47. The apparatus of claim 46, wherein the set of cached images comprises a current set of cached images at a point of navigation, a first set of cached images in a first direction from the point of navigation and a second set of cached images in a second direction from the point of navigation.

48. (canceled)

49. The apparatus of claim 46, wherein the apparatus is caused to display the set of cached images.

50-51. (canceled)
